(19) United States
(12) Patent Application Publication
(10) Pub. No.: US 2024/0152033 A1
(43) Pub. Date: May 9, 2024

(54) OPTICAL SYSTEM

(71) Applicant: TDK TAIWAN CORP., Taoyuan City (TW)

(72) Inventors: Chen-Hung CHAO, Taoyuan City (TW); Po-Xiang ZHUANG, Taoyuan City (TW); Chao-Chang HU, Taoyuan City (TW); Yi-Ho CHEN, Taoyuan City (TW); Wei-Jhe SHEN, Taoyuan City (TW)

(21) Appl. No.: 18/501,404

(22) Filed: Nov. 3, 2023

Related U.S. Application Data
(60) Provisional application No. 63/422,734, filed on Nov. 4, 2022.
(60) Provisional application No. 63/446,562, filed on Feb. 17, 2023.

(51) Int. Cl. G03B 9/18

(52) U.S. Cl. CPC G03B 9/18

(57) ABSTRACT

An optical system is provided, including a movable part, a fixed part, and a driving assembly. The movable part is connected to a first optical element. The movable part is movable relative to the fixed part. The fixed part has a fixed part opening, wherein a light passes through the fixed part opening. The driving assembly drives the movable part to move relative to the fixed part. The first optical element at least partially overlaps the fixed part opening when the movable part is in a first position. When the movable part is in an extreme position, the first optical element does not overlap the fixed part opening.

### CROSS REFERENCE TO RELATED APPLICATIONS

This application claims the benefit of U.S. Provisional Application No. 63/422,734, filed Nov. 4, 2022, and 63/446,562, filed Feb. 17, 2023, the entirety of which is incorporated by reference herein.

### BACKGROUND OF THE INVENTION

### Field of the Invention

The present invention relates to an optical system, and in particular, it relates to an optical system with a driving assembly.

### Description of the Related Art

With the recent developments in science and technology, many electronic devices (such as tablets and other computers) nowadays have the functionality of taking pictures and recording videos. The use of these electronic devices is becoming more and more common. In addition to developing products that are more stable and have better optical quality, they are also moving towards convenient and thinner designs to provide users with more choices.

However, when an optical element (such as a lens) with a long focal length needs to be installed in the aforementioned electronic device, the thickness of the electronic device will increase, which is not conducive to improving the thinness and stability of the electronic device. In view of this, how to design optical systems that makes electronic devices thinner, lighter, and more stable has become an important issue.

### BRIEF SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, an optical system, includes a movable part, a fixed part, a movable part, and a driving assembly. The movable part is connected to a first optical element. The movable part is movable relative to the fixed part. The fixed part has a fixed part opening, and a light passes through the fixed part opening. The driving assembly drives the movable part to move relative to the fixed part. When the movable part is in a first position, the first optical element at least partially overlaps the fixed part opening. When the movable part is in an extreme position, the first optical element does not overlap the fixed part opening.

In some embodiments, the driving assembly includes a coil and a magnetic element. The optical system further includes a sensing element, sensing the movement of the movable part relative to the fixed part, and the sensing element corresponds to the magnetic element. The magnetic element has a first magnetic surface, facing the coil and the sensing element.

In some embodiments, when viewed along a direction perpendicular to the first magnetic surface, the center of the coil does not overlap the center of the magnetic element, the center of the coil and the center of the sensing element are arranged along a first direction, and the coil does not surround the sensing element. The first magnetic surface is perpendicular to the traveling direction of the light.

In some embodiments, the sensing element further includes a first axis, the first axis is parallel to the first magnetic surface and the first direction. The sensing element detects the relative position of the movable part and the fixed part by sensing the magnetic field on the first axis.

In some other embodiments, when the movable part is in the first position, when viewed along the direction perpendicular to the first magnetic surface, the sensing element at least partially do not overlap the magnetic element. When the movable part is in the extreme position, when viewed along the direction perpendicular to the first magnetic surface, the center of the sensing element does not overlap the magnetic element.

In some embodiments, when the movable part is located in the first position, the optical system forms a first opening with a plurality of first intersections arranged along the first opening; the first intersections are spaced apart from each other with different spaces. When the movable part is in a second position, the optical system forms a second opening with a plurality of second intersections arranged along the second opening; the second intersections are spaced apart from each other with different spaces. The area of the first opening is different from the area of the second opening. The shape of the first opening is different from the shape of the second opening.

In some embodiments, the optical system further includes a guiding assembly, the guiding assembly includes a first guiding element, and a first supporting element. The first guiding element has a linear structure to guide the movement of the first optical element. The first supporting element is movably connected to the first optical element, and the first optical element rotates relative to the first supporting element.

In some embodiments, there are more than one first guiding element, more than one first optical element, and more than one first supporting element, and the first guiding elements respectively guide the movement of the first optical elements, the first supporting elements are respectively movably connected to the first optical elements. The first optical elements are respectively located on both sides of the fixed part opening.

In some embodiments, the guiding assembly further includes a second guiding element and a second supporting element. The second guiding element has a non-linear structure, guiding the movement of a second optical element. The second supporting element is movably connected to the second optical element. The second optical element rotates relative to the second supporting element. The first guiding element and the second guiding element have different structures.

In some embodiments, the guiding assembly further includes third guiding element and a third supporting element. The third guiding element guides the movement of a third optical element. The third supporting element is movably connected to the third optical element, and the third optical element rotates relative to the third supporting element. The second guiding element and the third guiding element have the same structure

In some embodiments, the distance between the first supporting element and the second supporting element is greater than zero. The first optical element, the second optical element, and the third optical element have a plate-shaped structure and are parallel to each other. The first optical element, the second optical element, and the third optical element are all located on different planes.

In some embodiments, the movable part moves in a first dimension relative to the fixed part. The first optical element moves in a second dimension relative to the fixed part. The second optical element moves in a third dimension relative to the fixed part.

In some embodiments, when the movable part moves relative to the fixed part, the first optical element and the second optical element are driven to move. When the movable part moves at a constant speed relative to the fixed part, the speed of the first optical element relative to the fixed part is different from speed of the second optical element relative to the fixed part. The first optical element moves at a non-constant speed relative to the fixed part, and the second optical element moves at a constant speed relative to the fixed part.

In some embodiments, the first optical element includes a first end, a first head, and a first middle part. The first end has a first arc-shaped structure. The first head is closer to the first guiding element than the first end. The first middle part has a protruding structure. The first middle part is located between the first end and the first head. When the movable part is in the first position, the first end is at least partially not adjacent to the first opening. When the movable part is in the second position, the first end is adjacent to the second opening.

In some embodiments, the movable part connects the second optical element, and the second optical element includes a second end, a second head, and a second middle part. The second end has a second arc-shaped structure. The second head is closer to the second guiding element than the second end. The second middle part has a protruding structure. The second middle part is located between the second end and the second head. When the movable part is in the first position, the second end is adjacent to the first opening. One of the first intersections is between the first end and the second end.

In some embodiments, the maximum distance between the first end and the first opening is different from the maximum distance between the second end and the first opening, and the maximum distance between the first end and the second opening is different from the maximum distance between the second end and the second opening. The first end and the second end have different structures.

In some embodiments, when the movable part is in the second position, the second end is at least partially not adjacent to the second opening, the second end is adjacent to the first opening, and one of the second intersections is located between the first end and the second end.

In some embodiments, the maximum distance between the first end and the second opening is less than the maximum distance between the second end and the second opening, and the maximum distance between the first end and the first opening is greater than the maximum distance between the second end and the first opening.

In some embodiments, the movable part connects the third optical element, and the third optical element includes a third end, a third head, and a third middle part. The third head is closer to the third guiding element than the third end. The third middle part with a protruding structure. When the movable part is in the first position, the third end is adjacent to the first opening, and another one of the first intersections is between the first end and the third end.

In some embodiments, when the movable part is in the first position, the first end and the third end have different structures. The second end and the third end have different structures. The second middle part and the third middle part have different structures. The first middle part and the third middle part have different structures. The first middle part and the second middle part have different structures. When the movable part is in the second position, the third end is adjacent to the second opening, and another one of the second intersections is between the first end and the third end.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a front perspective view of an optical system, according to certain aspects of the present disclosure.

FIG. 2A is an exploded perspective view of the optical system, according to certain aspects of the present disclosure.

FIG. 2B is an exploded perspective view of the optical system with the first optical element, the second optical element, and the third optical element have been assembled, according to certain aspects of the present disclosure.

FIG. 3A is a front perspective view of a driving assembly and a sensing element, according to certain aspects of the present disclosure.

FIG. 3B is a side view of a driving assembly and a sensing element, according to certain aspects of the present disclosure.

FIG. 3C is a side view of a driving assembly and a sensing element, according to other features of the present disclosure.

FIG. 4 is a top view of the optical system, according to certain aspects of the present disclosure, the case of the optical system is removed for illustrative purposes.

FIG. 5A is a top view of the first optical element, according to certain aspects of the present disclosure.

FIG. 5B is a top view of the second optical element, according to certain aspects of the present disclosure.

FIG. 5C is a top view of the third optical element, according to certain aspects of the present disclosure.

FIG. 6A is a cross-sectional view of the optical system along line A-A of FIG. 1, according to certain aspects of the present disclosure.

FIG. 6B is an enlarged detailed view of FIG. 6A, according to certain aspects of the present disclosure.

FIG. 7A is a top view of the optical system in a first position, according to certain aspects of the present disclosure, the case of the optical system is removed for illustrative purposes.

FIG. 7B is a diagram showing the relationship between a relative movement distance of the first leading element and the first guiding element and the rotation angle of the movable part, according to certain aspects of the present disclosure.

FIG. 7C is a diagram showing the relationship between a relative movement distance of the second leading element and the second guiding element and the rotation angle of the movable part, according to certain aspects of the present disclosure.

FIG. 8 is a top view of the optical system in a second position, according to certain aspects of the present disclosure, the case of the optical system is removed for illustrative purposes.

FIG. 9 is a top view of an optical system in an extreme position, according to certain aspects of the present disclosure, the case of the optical system is removed for illustrative purposes.

### DETAILED DESCRIPTION OF THE INVENTION

Various embodiments are described with reference to the accompanying drawings, wherein like reference characters are used to designate similar or equivalent elements throughout. The drawings are not to scale and are provided solely to illustrate features and characteristics of the present disclosure. It is understood that many specific details, relationships, and methods are set forth to provide a comprehensive understanding. However, one of ordinary skill in the art will readily recognize that various embodiments may be practiced without one or more of the specific details or in other ways. In some instances, well-known structures or operations are not shown in detail for illustrative purposes. Various embodiments are not limited to the order in which actions or events are displayed, as some actions may occur in a different order and/or concurrently with other actions or events. Furthermore, not all actions or events shown may be required to implement certain features and characteristics of the present disclosure.

For the purposes of this embodiment, unless expressly stated otherwise, the singular includes the plural and vice versa. The term “including” means, “including without limitation”. In addition, similar words such as “about (bout, almost, substantially, approximately)” and similar words may here mean, for example, “at”, “near, nearly at”, “at 3% “Within 3-5% of”, “within acceptable manufacturing tolerances” or any logical combination thereof. Additionally, the terms “vertical” or “horizontal” are intended to additionally include “within 3-5%” of the vertical or horizontal direction, respectively. In addition, directional terms such as “top,” “bottom,” “left,” “right,” “above,” and “below” are intended to relate to the equivalent directions depicted in the reference illustration; from the reference object or component Understood in context, such as from the usual position of the object or element; or such other description.

It will be understood that, although the terms “first”, “second”, etc. may be used herein to describe various elements, layers and/or portions, these elements, layers and/or portions should not be referred to as such. The terms are limited and are only used to distinguish between different components, layers and/or sections. Thus, a first element, layer and/or section discussed below could be termed a second element, layer and/or section without departing from the teachings of some embodiments of the present disclosure. In addition, for the sake of simplicity, terms such as “first” and “second” may not be used to distinguish different components in the specification. Without departing from the scope defined in the appended patent application, the first element and/or the second element described in the patent application can be interpreted as any element consistent with the description in the specification.

It should be noted that the technical solutions provided in different embodiments below could be replaced, combined or mixed with each other to constitute another embodiment without violating the spirit of the present disclosure.

The present disclosure relates to an optical system, which has a guiding assembly. The guiding assembly is driven by a driving assembly to drive the movable part and the optical element, thereby adjusting the photographic imaging of the optical system to adapt to different photographic needs.

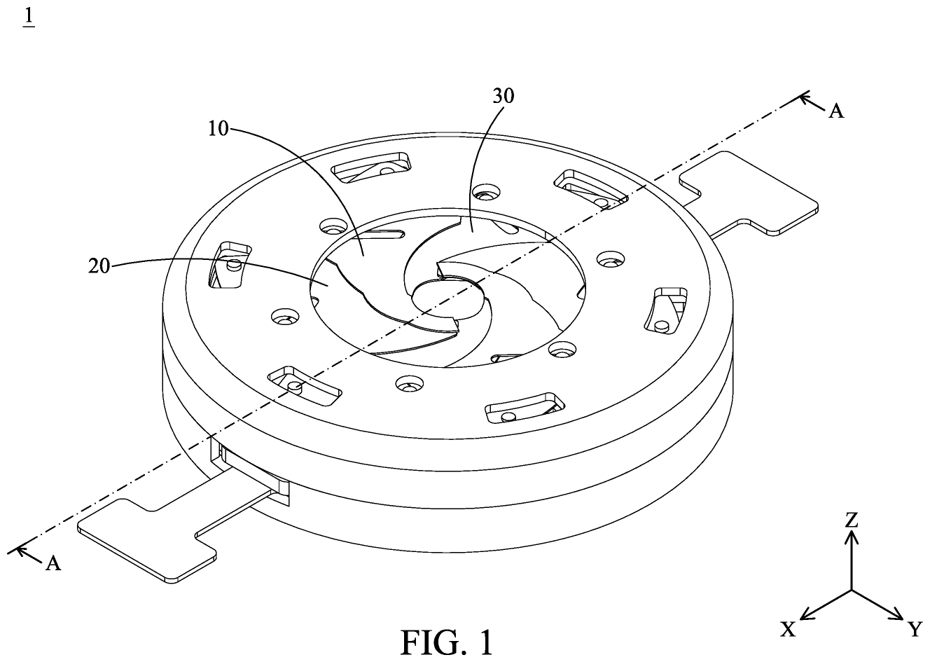

First, please refer to FIG. 1. FIG. 1 is a front perspective view of the optical system 1, according to certain aspects of the present disclosure.

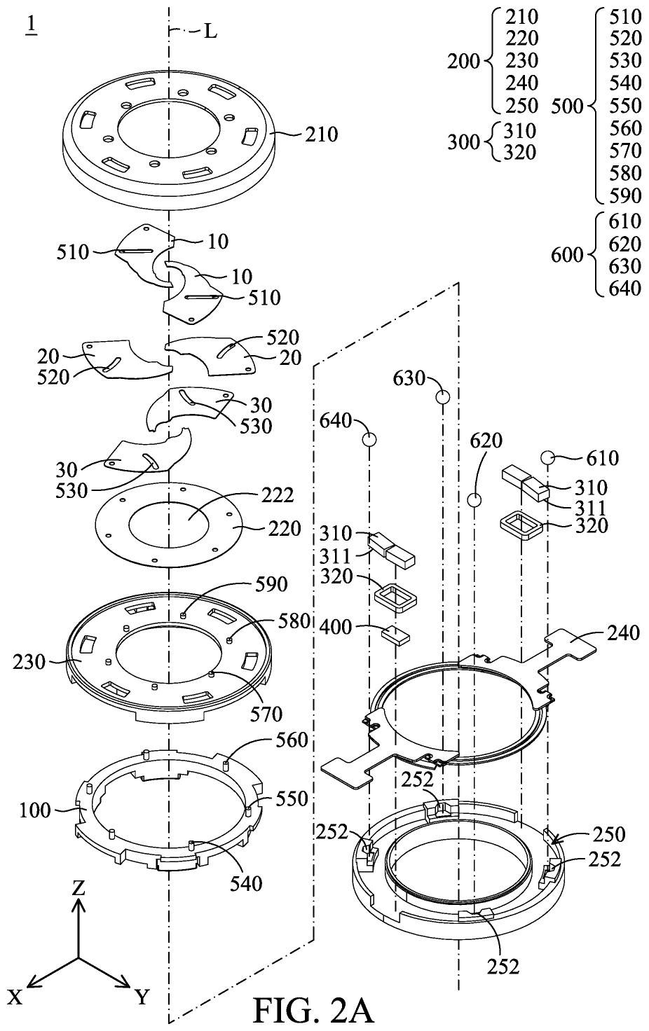

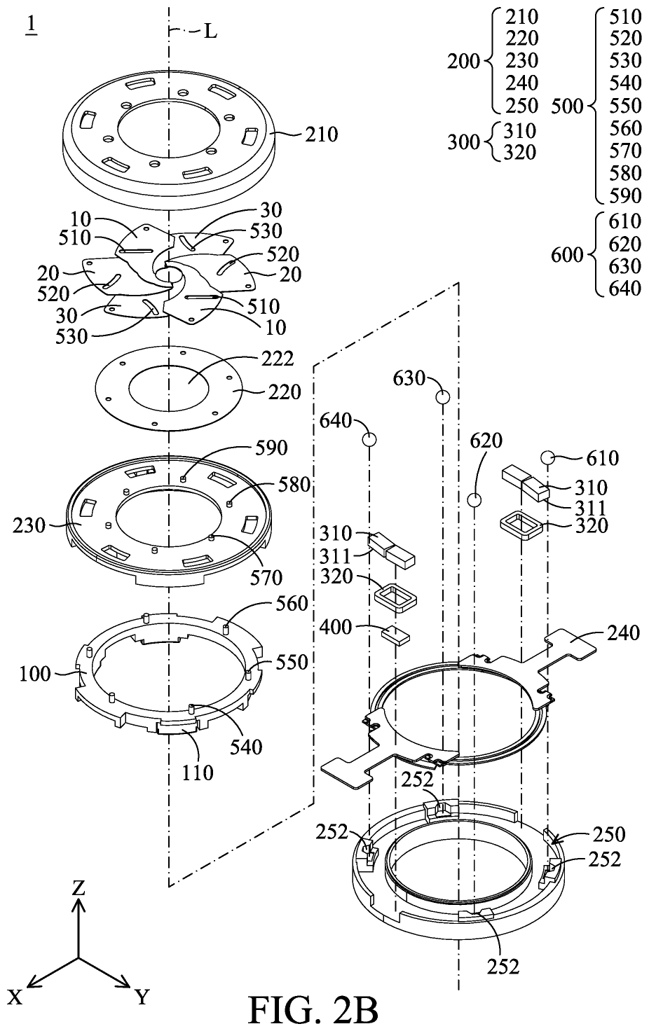

Please refer to FIG. 2A and FIG. 2B. FIG. 2A is an exploded perspective view of optical system 1, according to certain aspects of the present disclosure. FIG. 2B is an exploded perspective view of the optical system 1, according to certain aspects of the present disclosure, with the first optical element 10, the second optical element 20, and the third optical element 30 have been assembled.

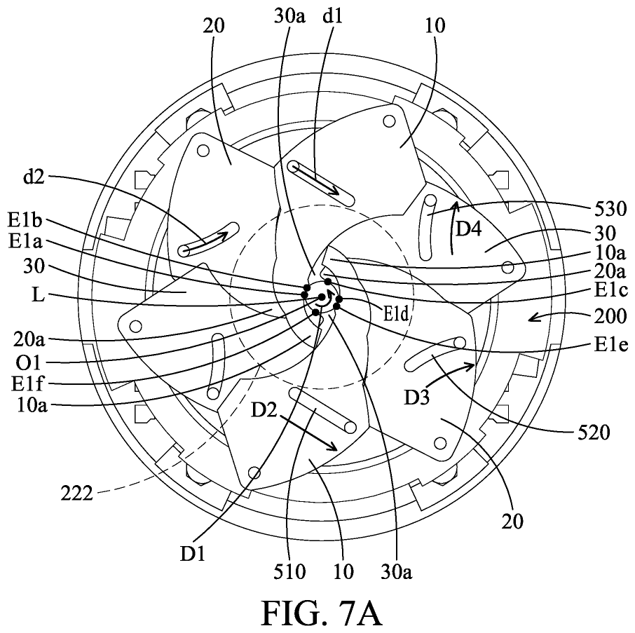

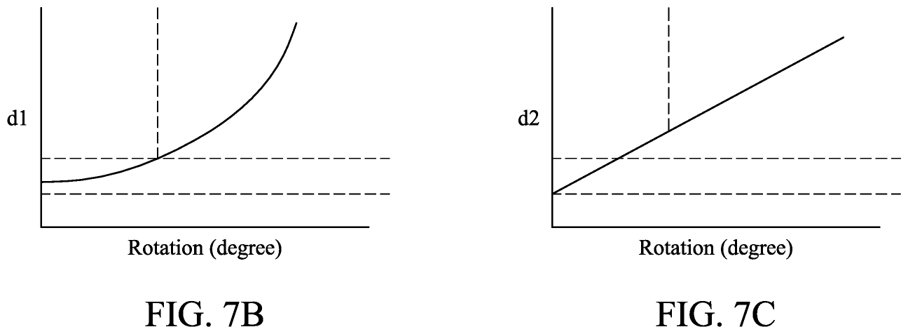

The optical system 1 includes a first optical element 10, a second optical element 20, a third optical element 30, a movable part 100, a fixed part 200, a driving assembly 300, a sensing element 400, and a guiding assembly 500, and a connecting assembly 600. The movable part 100 is connected to the first optical element 10, the second optical element 20, and the third optical element 30. The movable part 100 is movable relative to the fixed part 200. The driving assembly 300 drives the movable part 100 to move relative to the fixed part 200. The sensing element 400 senses the movement of the movable part 100 relative to the fixed part 200. The movable part 100 may move relative to the fixed part 200 in a first dimension D1 (see FIG. 7A).

The fixed part 200 includes a case 210, a light shielding element 220, a fixed body 230, a circuit assembly 240, and a base 250. The light shielding element 220 of the fixed part 200 has a fixed part opening 222. Light L passes through the fixed part opening 222 so that the light L may be incident into the optical system 1 from the outside. The case 210 and the base 250 may be connected to each other and form an internal space to accommodate other elements of the optical system 1, such as the first optical element 10, the second optical element 20, and the third optical element 30. The case 210 may be disposed above the first optical element 10, the second optical element 20, and the third optical element 30 to prevent unwanted foreign matter from entering the optical system 1. The base 250 may have four grooves 252.

When the movable part 100 moves relative to the fixed part 200, the first optical element 10, the second optical element 20, and the third optical element 30 are driven to move. For example, the movable part 100 may move around the optical axis of the light L relative to the fixed part 200, and the first optical element 10, the second optical element 20, and the third optical element 30 may move around the optical axis of the light L with the movable part 100 relative to the fixed part 200.

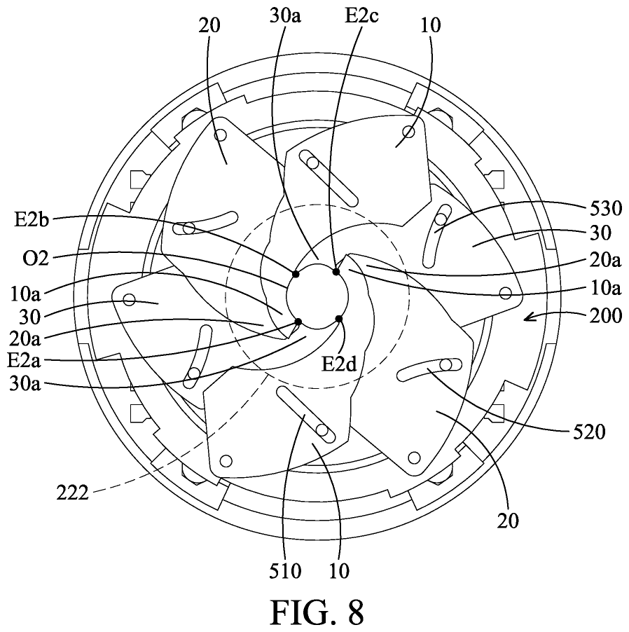

The first optical element 10 may move relative to the fixed part 200 in a second dimension D2 (see FIG. 7A). The second optical element 20 may move relative to the fixed part 200 in a third dimension D3 (see FIG. 7A). When the movable part 100 moves at a constant speed relative to the fixed part 200, the moving speed of the first optical element 10 relative to the fixed part 200 is different from the moving speed of the second optical element 20 relative to the fixed part 200. The first optical element 10 moves at a non-constant speed relative to the fixed part 200. The second optical element 20 moves at a constant speed relative to the fixed part 200, as will be described in more detail below with respect to FIG. 7A to FIG. 8.

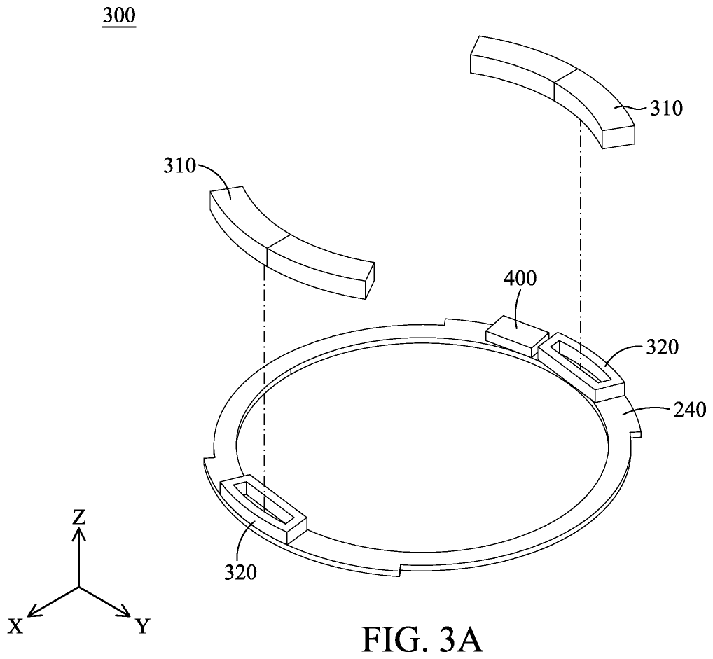

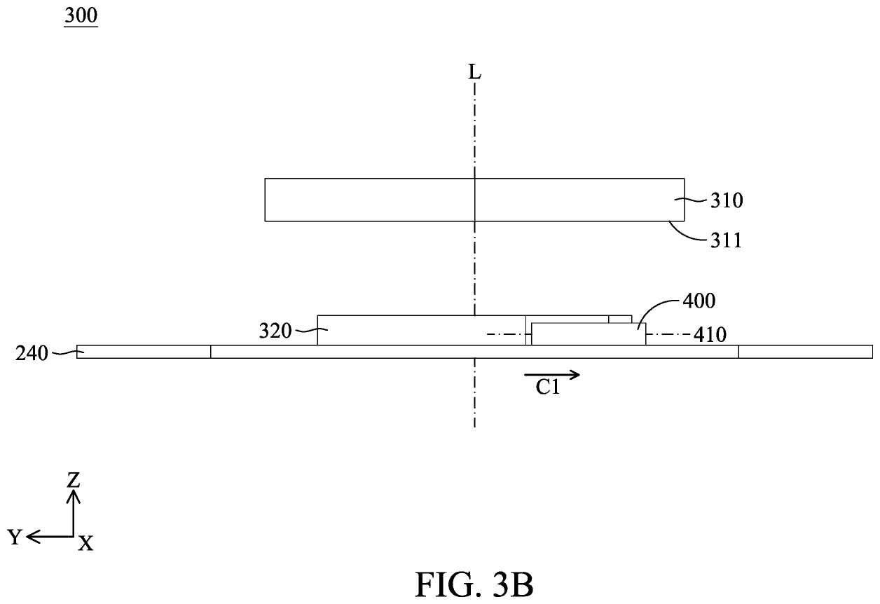

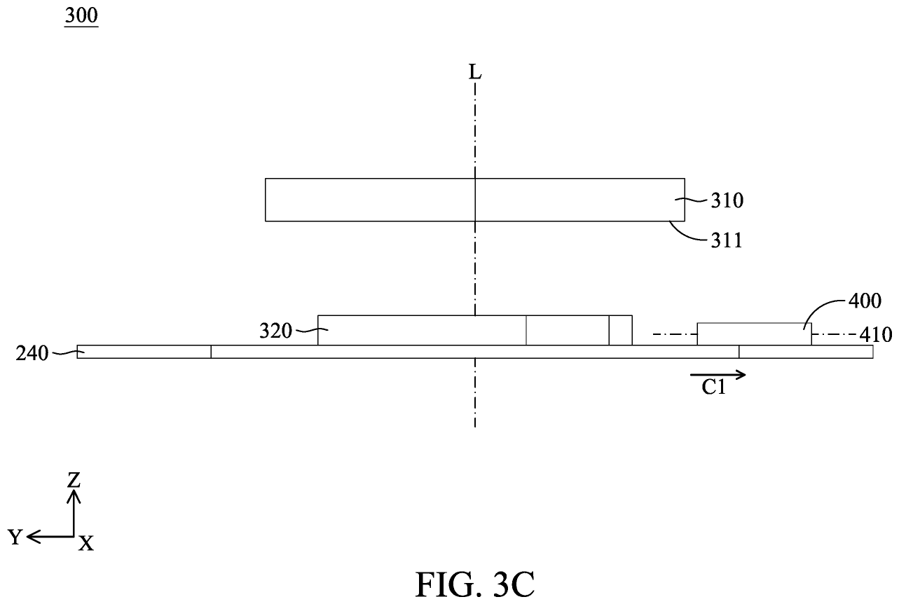

Next, please see FIG. 3A and FIG. 3B. FIG. 3A is a front perspective view of the driving assembly 300 and the sensing element 400, according to certain aspects of the present disclosure. FIG. 3B is a side view of the driving assembly 300 and the sensing element 400, according to certain aspects of the present disclosure.

The driving assembly 300 includes a magnetic element 310 and a coil 320. According to some embodiments of the present disclosure, the magnetic element 310 may be disposed on the movable part 100, and the coil 320 may be disposed on the circuit assembly 240 of the fixed part 200 to drive the movable part 100 to move relative to the fixed part 200.

The magnetic element 310 includes a first magnetic surface 311 (see FIG. 3B). The first magnetic surface 311 faces the coil 320 and the sensing element 400. The first magnetic surface 311 may face the circuit assembly 240 of the fixed part 200.

According to some embodiments of the present disclosure, the first magnetic surface 311 is perpendicular to the traveling direction of the light L. When viewed along the direction perpendicular to the first magnetic surface 311, the center of the coil 320 does not overlap the center of the magnetic element 310. The center of the coil 320 and the center of the sensing element 400 arrange in a first direction C1, and the coil 320 does not surround the sensing element 400.

The sensing element 400 corresponds to the magnetic element 310. The sensing element 400 further includes a first axis 410, and the first axis 410 is parallel to the first magnetic surface 311 and the first direction C1. The sensing element 400 detects the relative position of the movable part 100 and the fixed part 200 by sensing the magnetic field on the first axis 410.

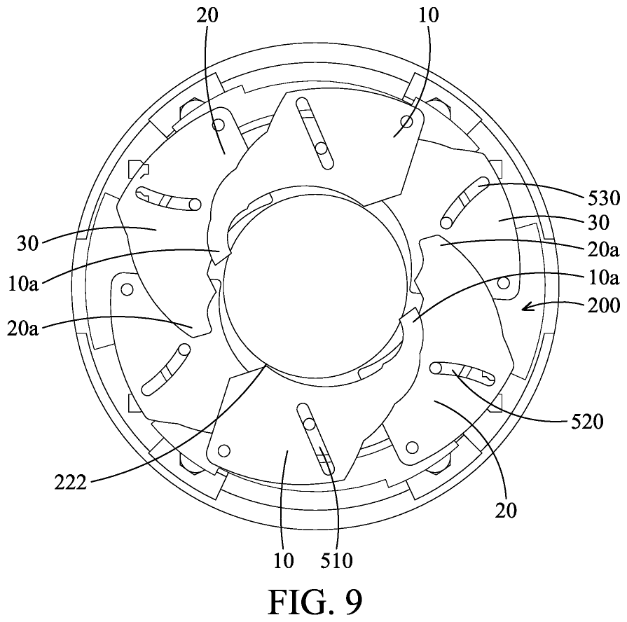

Next, please see FIG. 3C. FIG. 3C is a side view of the driving assembly 300 and the sensing element 400 according to other features of the present disclosure. The sensing element 400 may also be configured as shown in FIG. 3C. When the movable part 100 is in the first position (as will be described below with respect to FIG. 7A), the sensing element 400 at least partially does not overlap the magnetic element 310 when viewed along the direction perpendicular to the first magnetic surface 311. When the movable part 200 is in the extreme position (as will be described below with respect to FIG. 9), when viewed along the direction perpendicular to the first magnetic surface 311, the center of the sensing element 400 does not overlap the magnetic element 310.

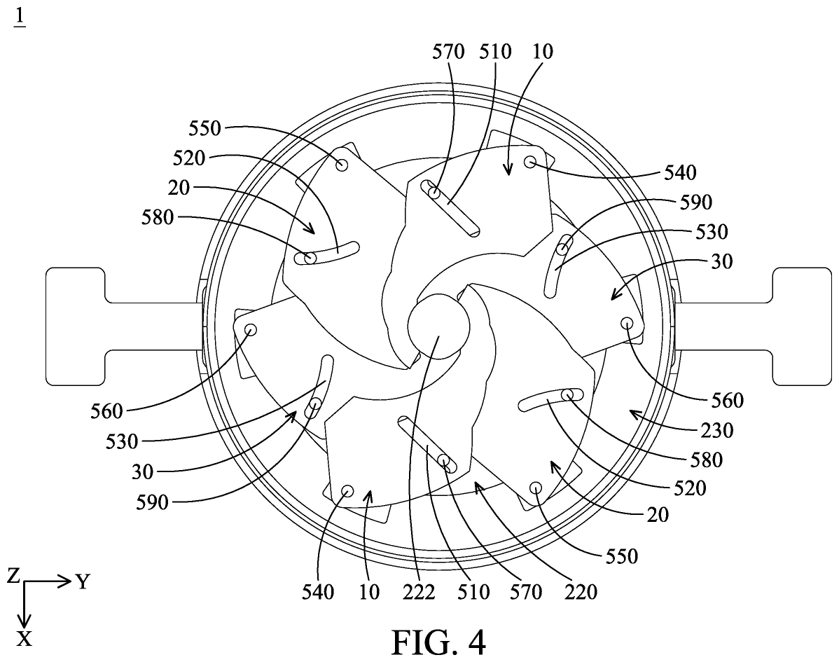

Next, please refer to FIG. 2B and FIG. 4 together. FIG. 4 is a top view of optical system 1, according to certain aspects of the present disclosure, with case 210 of optical system 1 removed for illustrative purposes. The guiding assembly 500 includes a first guiding element 510, a second guiding element 520, a third guiding element 530, a first supporting element 540, a second supporting element 550, a third supporting element 560, a first leading element 570, and a second leading element 580, and a third leading element 590. The first guiding element 510, the second guiding element 520, and the third guiding element 530 may be, for example, a groove-shaped structure, respectively located on the first optical element 10, the second optical element 20, and the third optical element 30. The first guiding element 510 has a linear structure and guides the movement of the first optical element 10. The second guiding element 520 has a non-linear structure and guides the movement of the second optical element 20. The third guiding element 530 guides the movement of the third optical element 30.

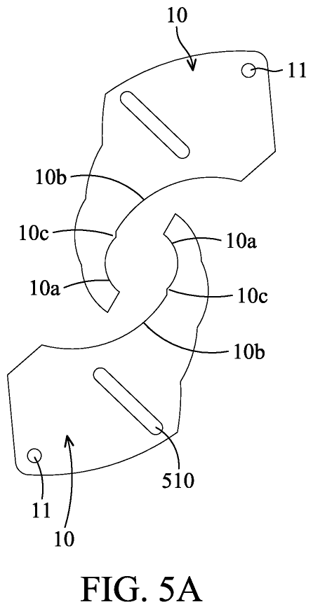

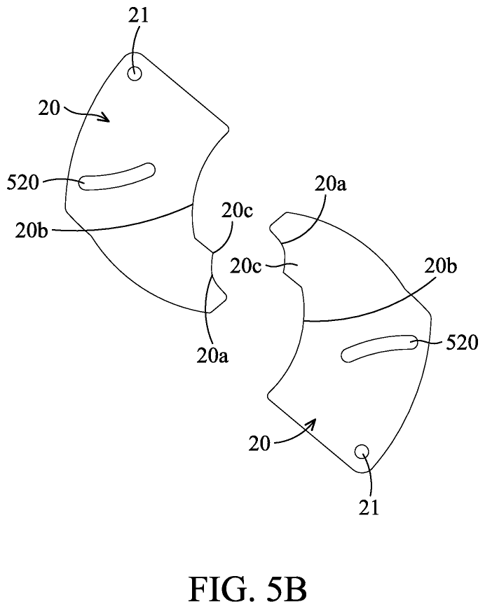

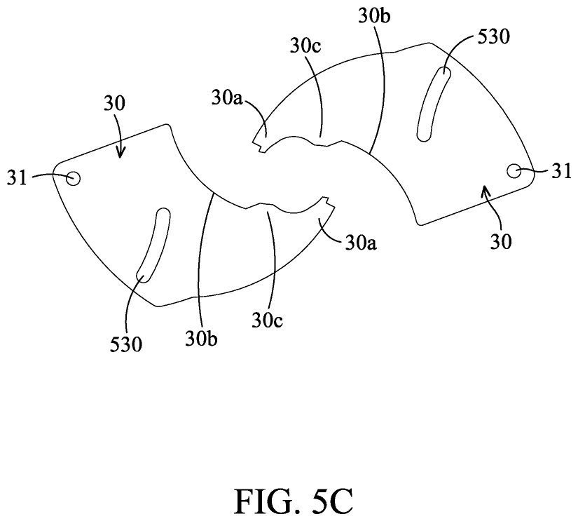

The first supporting element 540, the second supporting element 550, and the third supporting element 560 may be, for example, protruding structures located on the movable part 100. The first supporting element 540 may be movably connected to the first optical element 10 by passing through a hole 11 on the first optical element 10 (see FIG. 5A). The first optical element 10 may rotate relative to the first supporting element 540. The second supporting element 550 may be movably connected to the second optical element 20 by passing through a hole 21 on the second optical element 20 (see FIG. 5B). The second optical element 20 may rotate relative to the second supporting element 550. The third supporting element 560 may be movably connected to the third optical element 30 by passing through a hole 31 on the third optical element 30 (see FIG. 5C). The third optical element 30 may rotate relative to the third supporting element 560.

The first leading element 570, the second leading element 580, and the third leading element 590 may be, for example, protruding structures located on the fixed body 230 of the fixed part 200. The first leading element 570, the second leading element 580, and the third leading element 590 each passes through the first guiding element 510, the second guiding element 520, and the third guiding element 530. The first leading element 570 on the first optical element 10 may slide relative to the first guiding element 510. The second leading element 580 on the second optical element 20 may slide relative to the second guiding element 520. The third leading element 590 on the third optical element 30 may slide relative to the third guiding element 530.

According to some embodiments of the present disclosure, the first guiding element 510 and the second guiding element 520 have different structures. The second guiding element 520 and the third guiding element 530 have the same structure. There is a distance greater than zero between the first supporting element 540 and the second supporting element 550.

In the present embodiment shown in the present disclosure, the optical system 1 has two first guiding elements 510, two first optical elements 10, two first supporting elements 540, two second guiding elements 520, two second optical elements 20, two second supporting elements 550, two third guiding elements 530, two third optical elements 30, and two third supporting elements 560. The first guiding elements 510 respectively guide the movement of the first optical elements 10, and the first supporting elements 540 respectively movably connect the first optical elements 10. The first optical elements 10 are respectively located on both sides of the fixed part opening 222, that is, on opposite sides of the fixed part opening 222. The second guiding elements 520 respectively guide the movement of the second optical elements 20, and the second supporting elements 550 respectively movably connect the second optical elements 20. The second optical elements 20 are respectively located on both sides of the fixed part opening 222, that is, on opposite sides of the fixed part opening 222. The third guiding elements 530 respectively guide the movement of the third optical elements 30, and the third supporting elements 560 respectively movably connect the third optical elements 30. The third optical elements 30 are respectively located on both sides of the fixed part opening 222, that is, on opposite sides of the fixed part opening 222.

According to some embodiments of the present disclosure, the first optical element 10, the second optical element 20, and the third optical element 30 may be blades, filter elements, or lenses.

Next, please see FIG. 5A. FIG. 5A is a top view of the first optical element 10, according to certain aspects of the present disclosure. The first optical element 10 has a plate-like structure and has a first end 10a, a first head 10b, and a first middle part 10c. The first end 10a has a first arc-shaped structure. The first head 10b is closer to the first guiding element 510 than the first end 10a. The first middle part 10c has a protruding structure and is located between the first end 10a and the first head 10b.

Next, please see FIG. 5B next. FIG. 5B is a top view of the second optical element 20, according to certain aspects of the present disclosure. The second optical element 20 has a plate-like structure and has a second end 20a, a second head 20b, and a second middle part 20c. The second end 20a has a second arc-shaped structure. The second head 20b is closer to the second guiding element 520 than the second end 10a. The second middle part 20c has a protruding structure and is located between the second end 20a and the second head 20b. The first end 10a and the second end 20a have different structures.

Please see FIG. 5C next. FIG. 5C is a top view of third optical element 30, according to certain aspects of the present disclosure. The third optical element 30 has a plate-like structure and has a third end 30a, a third head 30b, and a third middle part 30c. The third head 30b is closer to the third guiding element 530 than the third end 30a. The third middle part 30c has a protruding structure and is located between the third end 30a and the third head 30b.

The first end 10a and the third end 30a have different structures, and the second end 20a and the third end 30a have different structures. The second middle part 20c and the third middle part 30c have different structures, the first middle part 10c and the third middle part 30c have different structures, and the first middle part 10c and the second middle part 20c have different structures. The first optical element 10 and the third optical element 30 have different structures, and the second optical element 20 and the third optical element 30 have different structures.

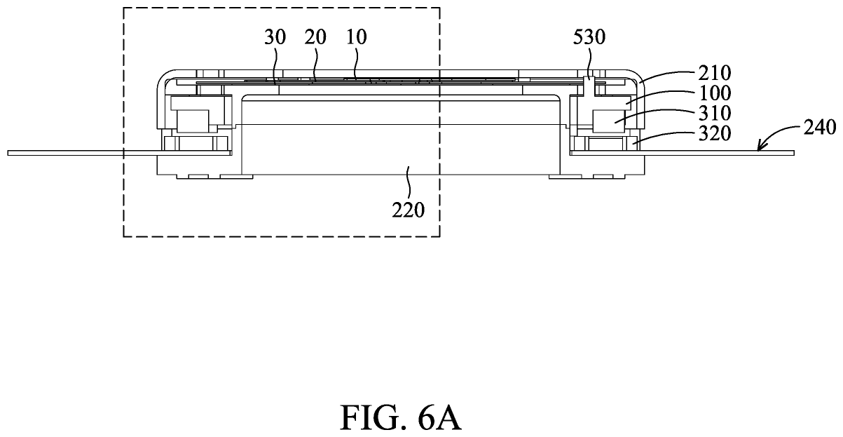

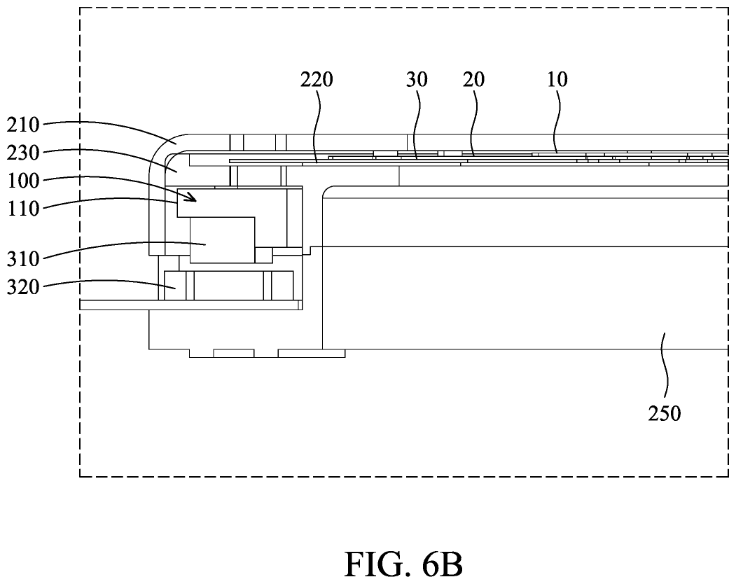

Next, please see FIG. 6A and FIG. 6B. FIG. 6A is a cross-sectional view of the optical system 1 along line A-A of FIG. 1, according to certain aspects of the present disclosure. FIG. 6B is an enlarged view of FIG. 6A, according to certain aspects of the present disclosure. The first optical element 10, the second optical element 20, and the third optical element 30 are parallel to each other. The first optical element 10, the second optical element 20, and the third optical element 30 are all located on different planes.

Next, please refer to FIG. 2B again. The connecting assembly 600 may be disposed between the fixed part 200 and the movable part 100 to avoid direct friction between the fixed part 200 and the movable part 100.

The connecting assembly 600 may include a first connection element 610, a second connection element 620, a third connection element 630, and a fourth connection element 640. The first connecting element 610, the second connecting element 620, the third connecting element 630, and the fourth connecting element 640 may be respectively located in four grooves 252 on the base 250.

According to some embodiments of the present disclosure, the first connecting element 610, the second connecting element 620, the third connecting element 630, and the fourth connecting element 640 may have a spherical shape. For example, the first connecting element 610, the second connecting element 620, the third connecting element 630, and the fourth connecting element 640 may each be a ball. That is, one ball may be accommodated in each of the four grooves 252 on the base 250.

According to some other embodiments of the present disclosure, the first connecting element 610, the second connecting element 620, the third connecting element 630, and the fourth connecting element 640 may be two balls respectively. That is, two balls may be accommodated in the four grooves 252 on the base 250 respectively.

The outer surface 110 of the movable part 100 may be an arched surface. For example, the outer surface 110 of the movable part 100 may be an arched surface parallel to the direction of the light axis, with a center of the movable part 100 as the center. Therefore, the first connecting element 610, the second connecting element 620, the third connecting element 630, and the fourth connecting element 640 may move smoothly relative to the outer surface 110 of the movable portion 100.

The outer surface 110 of the movable part 100 abuts the first connecting element 610, the second connecting element 620, the third connecting element 630, and the fourth connecting element 640. The movable part 100 abuts the first connecting element 610, the second connecting element 620, the third connecting element 630 and the fourth connecting element 640 in the groove 252 of the fixed part 200. In other words, the first connecting element 610, the second connecting element 620, the third connecting element 630 and the fourth connecting element 640 may abut against the outer surface 110 of the movable part 100 and the groove 252 of the fixed part 200.

Therefore, the movable part 100 will not have a linear movement relative to the fixed part 200 (for example, movement along the X-axis or Y-axis); however, the movable part 100 may rotate relative to the fixed part 200 (for example, around the optical axis of light L). The first connecting element 610, the second connecting element 620, the third connecting element 630, and the fourth connecting element 640 may prevent the movable part 100 from generating excessive resistance (for example, friction force) when moving due to abutment, so it facilitates the movement of the movable part 100 relative to the fixed part 200.

Please see FIG. 7A next. FIG. 7A is a top view of optical system 1 in a first position, according to certain aspects of the present disclosure, with the case 210 of the optical system 1 removed for illustrative purposes. When the movable part 100 is located in the first position, the first optical element 10 at least partially overlaps the fixed part opening 222 of the fixed part 200. Therefore, the first optical element 10 may block part of the light L to control the amount of incident light going into the optical system 1.

When the movable part 100 is located in the first position, the first optical element 10, the second optical element 20, and the third optical element 30 form a first opening O1 with a plurality of first intersections E1a, E1b, E1c, E1d, E1e, and E1f. The first intersections are arranged along the first opening O1, and are spaced apart from each other with different spaces. For example, see FIG. 7A, the distance between E1a and E1b is different from the distance between E1b and E1c, the distance between E1c and E1d is different from the distance between E1d and E1e, etc. The third end 30a is adjacent to the first opening O1. The first end 10a is not adjacent to the first opening O1 at least partially, that is, the first end 10a is not contiguous to the first opening O1 at least partially. The second end 20a is adjacent to the first opening O1. That is, in the first position, the first opening O1 is formed by the first end 10a of the first optical element 10, the second end 20a of the second optical element 20, and the third end 30a of the third optical element 30.

A first intersection Ela of the first opening O1 is located between the first end 10a and the second end 20a. Another first intersection E1b is located between the first end 10a and the third end 30a. Since the first end 10a is at least partially not adjacent to the first opening O1, therefore there is a distance between the first end 10a and the first opening O1. Therefore, the maximum distance between the first end 10a and the first opening O1 is greater than the maximum distance between the second end 20a and the first opening O1.

By the electromagnetic driving force generated by the magnetic element 310 and the coil 320 of the driving assembly 300, the movable part 100 may move in the first dimension D1 relative to the fixed part 200. That is, the movable part 100 moves around the optical axis of the light L, and the first optical element 10, the second optical element 20, and the third optical element 30 may move around the optical axis of the light L as the movable part 100 moves relative to the fixed part 200. It should be noted that the first optical element 10 is guided by the first guiding element 510 and moves relative to the fixed part 200 in the second dimension D2. The second optical element 20 is guided by the second guiding element 520 and moves in the third dimension D3 relative to the fixed part 200. The third optical element 30 is guided by the third guiding element 530 and moves relative to the fixed part 200 in a fourth dimension D4.

Next, please refer to FIG. 7B and FIG. 7C. FIG. 7B is a diagram showing the relationship between a relative movement distance d1 of the first leading element 570 and the first guiding element 510 and the rotation angle of the movable part 100, according to certain aspects of the present disclosure. FIG. 7C is a diagram showing a relative movement distance d2 of the second leading element 580 and the second guiding element 520 and the rotation angle of the movable part 100, according to certain aspects of the present disclosure. That is, when the movable part 100 moves at a constant speed relative to the fixed part 200 (rotates at a constant speed around the optical axis of the light L), the first leading element 570 performs a relative movement at a non-constant speed in the first guiding element 510. At the same time, the second leading element 580 performs a relative movement with constant speed in the second guiding element 520. That is, the speed of the first optical element 10 relative to the fixed part 200 different from the speed of the second optical element 20 relative to the fixed part 200. The first optical element 10 moves at a non-constant speed relative to the fixed part 200, and the second optical element 20 moves at a constant speed relative to the fixed part 200. The third optical element 30, as well as the second optical element 20, moves at a constant speed relative to the fixed part 200. The speed of the first optical element 10 relative to the fixed part 200 is different from the speed of the third optical element 30 relative to the fixed part 200.

Please refer to FIG. 8. FIG. 8 is a top view of the optical system 1 in the second position, according to certain aspects of the present disclosure, the case 210 of the optical system 1 is removed for illustrative purposes. As shown in FIG. 8, when the movable part 100 is in the second position, the first optical element 10 at least partially overlaps the fixed part opening 222 of the fixed part 200. When the movable part 100 is in the second position, the first optical element 10 and the third optical element 30 form a second opening O2 with a plurality of second intersections E2a, E2b, E2c, and E2d arranged along the second openings O2. The second intersections are spaced apart from each other with different spaces. For example, see FIG. 8, the distance between E2a and E2b is different from the distance between E2b and E2c, the distance between E2c and E2d is different from the distance between E2d and E2a, etc. When the movable part 100 is in the second position, the first end 10a is adjacent to the second opening O2, and the second end 20a is at least partially not adjacent to the second opening O2, that is, the second end 20a is at least partially not contiguous to the first opening O2. The third end 30a is adjacent to the second opening O2. That is, in the second position, the second opening O2 is formed by the first end 10a of the first optical element 10 and the third end 30a of the third optical element 30. In other embodiments, in the second position, the second opening O2 may be formed by the first end 10a of the first optical element 10, the second end 20a of the second optical element 20, and the third end 30a of the third optical element 30.

A second intersection E2a of the second opening O2 is between the first end 10a and the second end 20a. Another second intersection E2b is located between the first end 10a and the third end 30a. Since the second end 20a is not adjacent to the second opening O2, which is formed by the first end 10a of the first optical element 10, there is a distance between the second end 20a and the second opening O2. Therefore, the maximum distance between the first end 10a and the second opening O2 is smaller than the maximum distance between the second end 20a and the second opening O2. The ratio of the distance from the second intersections E2a to E2b to the distance from the second intersections E2b to E2c is different from the ratio of the distance from the first intersections Ela to E1b to the distance from the first intersections E1b to E1c. The ratio of the distance from the second intersections E2a to E2b to the distance from the second intersections E2b to E2c is greater than the ratio of the distance from the first intersections Ela to E1b to the distance from the first intersections E1b to E1c.

The area of the first opening O1 is different from the area of the second opening O2. The shape of the first opening O1 is different from the shape of the second opening O2.

Please refer to FIG. 9. FIG. 9 is a top view of the optical system 1 in an extreme position, according to certain aspects of the present disclosure, the case 210 of the optical system 1 is removed for illustrative purposes. As shown in FIG. 9, when the movable part 100 is in the extreme position, the first optical element 10 does not overlap the fixed part opening 222 of the fixed part 200. Therefore, the first optical element 10, the second optical element 20, and the third optical element 30 do not block the light L, so that the light L may completely pass through the optical system 1.

In the first position, the second position, and the extreme position, the first optical element 10, the second optical element 20, the third optical element 30, and the fixed part opening 222 form different aperture sizes. As a result, they may be controlled by controlling the driving assembly to drive the movable part to control the amount of light L passing through the optical system 1 to achieve the required amount of incident light. Utilizing the partial or the whole structures of the first end 10a, the second end 20a, and the third end 30a of the first optical element 10, the second optical element 20, and the third optical element 30 in the first and the second position, they are diversely designed such that when they form an aperture, the shape of the aperture may be approximately circular to achieve better imaging effects.

In summary, the optical system of the embodiment of the present disclosure may make the movable part move smoothly relative to the fixed part, and may change the size of the opening formed by the first optical element, the second optical element, and the third optical element by driving the movable part to adjust the amount of incident light. The first optical element, the second optical element, and the third optical element in the embodiment of the present disclosure may achieve multi-stage changes of the aperture, and may be used in more various applications.

Unless otherwise defined, all terms (including technical and scientific terms) used herein have the same meaning as commonly understood by one of ordinary skill in the art to which this disclosure belongs. It is understood that these terms, such as terms defined in commonly used dictionaries, should be interpreted to have a meaning consistent with the relevant technology and the background or context of the present disclosure, and should not be interpreted in an idealized or overly formal manner. Interpretation, unless specifically defined herein.

Although the embodiments of the present disclosure and their advantages have been disclosed above, it should be understood that any person with ordinary knowledge in the art can make changes and substitutions without departing from the spirit and scope of the present disclosure. and polish. In addition, the protection scope of the present disclosure is not limited to the processes, machines, manufacturing, material compositions, devices, methods and steps in the specific embodiments described in the specification. Anyone with ordinary knowledge in the relevant technical field can learn from the disclosure It is understood that processes, machines, manufacturing, material compositions, devices, methods and steps currently or developed in the future can be used according to the present disclosure as long as they can perform substantially the same functions or obtain substantially the same results in the embodiments described herein. Therefore, the protection scope of the present disclosure includes the above-mentioned processes, machines, manufacturing, material compositions, devices, methods and steps. In addition, each claimed patent scope constitutes an individual embodiment, and the protection scope of the present disclosure also includes the combination of each claimed patent scope and embodiments.

What is claimed is:

1. An optical system, comprising:
a movable part connected to a first optical element;
a fixed part, wherein the movable part is movable relative to the fixed part, and the fixed part has a fixed part opening, and a light passes through the fixed part opening; and
a driving assembly, driving the movable part to move relative to the fixed part;
wherein when the movable part is in a first position, the first optical element at least partially overlaps the fixed part opening; and
when the movable part is in an extreme position, the first optical element does not overlap the fixed part opening.

2. The optical system as claimed in claim 1, wherein the driving assembly includes a coil and a magnetic element;
the optical system further includes a sensing element, sensing the movement of the movable part relative to the fixed part, and the sensing element corresponds to the magnetic element; and
the magnetic element has a first magnetic surface, facing the coil and the sensing element.

3. The optical system as claimed in claim 2, wherein:
when viewed along a direction perpendicular to the first magnetic surface, the center of the coil does not overlap the center of the magnetic element, the center of the coil and the center of the sensing element are arranged along a first direction, and the coil does not surround the sensing element;
the first magnetic surface is perpendicular to the traveling direction of the light.

4. The optical system as claimed in claim 2, wherein the sensing element further includes a first axis, the first axis is parallel to the first magnetic surface and the first direction;
the sensing element detects the relative position of the movable part and the fixed part by sensing the magnetic field on the first axis.

5. The optical system as claimed in claim 2, wherein:
when the movable part is in the first position, when viewed along the direction perpendicular to the first magnetic surface, the sensing element at least partially do not overlap the magnetic element;
when the movable part is in the extreme position, when viewed along the direction perpendicular to the first magnetic surface, the center of the sensing element does not overlap the magnetic element.

6. The optical system as claimed in claim 2, wherein:
when the movable part is located in the first position, the optical system forms a first opening with a plurality of first intersections arranged along the side of the first opening; the first intersections are spaced apart from each other with different spaces;
when the movable part is in a second position, the optical system forms a second opening with a plurality of second intersections arranged along the side of the second opening; the second intersections are spaced apart from each other with different spaces;
the area of the first opening is different from the area of the second opening;
the shape of the first opening is different from the shape of the second opening.

7. The optical system as claimed in claim 6, further including a guiding assembly, wherein the guiding assembly includes:
a first guiding element, having a linear structure to guide the movement of the first optical element;
a first supporting element movably connected to the first optical element, and the first optical element rotates relative to the first supporting element.

8. The optical system as claimed in claim 7, wherein there are more than one first guiding element, more than one first optical element, and more than one first supporting element, and the first guiding elements respectively guide the movement of the first optical elements, the first supporting elements are respectively movably connected to the first optical elements;
the first optical elements are respectively located on both sides of the fixed part opening.

9. The optical system as claimed in claim 7, wherein the guiding assembly further includes:
a second guiding element, having a non-linear structure, guiding the movement of a second optical element; and
a second supporting element movably connected to the second optical element, the second optical element rotates relative to the second supporting element;
the first guiding element and the second guiding element have different structures.

10. The optical system as claimed in claim 9, wherein the guiding assembly further includes:
a third guiding element, guiding the movement of a third optical element; and
a third supporting element movably connected to the third optical element, and the third optical element rotates relative to the third supporting element; wherein
the second guiding element and the third guiding element have the same structure.

11. The optical system as claimed in claim 10, wherein:
the distance between the first supporting element and the second supporting element is greater than zero;
the first optical element, the second optical element, and the third optical element have a plate-shaped structure and are parallel to each other; and
the first optical element, the second optical element, and the third optical element are all located on different planes.

12. The optical system as claimed in claim 10, wherein the movable part moves in a first dimension relative to the fixed part;
the first optical element moves in a second dimension relative to the fixed part;
the second optical element moves in a third dimension relative to the fixed part.

13. The optical system as claimed in claim 10, wherein:
when the movable part moves relative to the fixed part, the first optical element and the second optical element are driven to move;
when the movable part moves at a constant speed relative to the fixed part, the speed of the first optical element relative to the fixed part is different from speed of the second optical element relative to the fixed part; and
the first optical element moves at a non-constant speed relative to the fixed part, and the second optical element moves at a constant speed relative to the fixed part.

14. The optical system as claimed in claim 10, wherein:
the first optical element includes:
a first end, having a first arc-shaped structure;
a first head, being closer to the first guiding element than the first end; and
a first middle part, having a protruding structure, wherein the first middle part is located between the first end and the first head; and
when the movable part is in the first position, the first end is at least partially not adjacent to the first opening; and
when the movable part is in the second position, the first end is adjacent to the second opening.

15. The optical system as claimed in claim 14, wherein:
the movable part connects the second optical element, and the second optical element includes:
a second end, having a second arc-shaped structure;
a second head, being closer to the second guiding element than the second end; and
a second middle part, having a protruding structure, wherein the second middle part is located between the second end and the second head; and
when the movable part is in the first position, the second end is adjacent to the first opening, and one of the first intersections is between the first end and the second end.

16. The optical system as claimed in claim 15, wherein:
the maximum distance between the first end and the first opening is different from the maximum distance between the second end and the first opening, and
the maximum distance between the first end and the second opening is different from the maximum distance between the second end and the second opening; wherein
the first end and the second end have different structures.

17. The optical system as claimed in claim 15, wherein:
when the movable part is in the second position, the second end is at least partially not adjacent to the second opening, and the second end is adjacent to the second opening, and
one of the second intersections is located between the first end and the second end.

18. The optical system as claimed in claim 15, wherein:
the maximum distance between the first end and the first opening is greater than the maximum distance between the second end and the first opening, and
the maximum distance between the first end and the second opening is less than the maximum distance between the second end and the second opening.

19. The optical system as claimed in claim 15, wherein the movable part connects the third optical element, and the third optical element includes:
a third end;
a third head, wherein the third head is closer to the third guiding element than the third end; and
a third middle part with a protruding structure;
when the movable part is in the first position, the third end is adjacent to the first opening, and another one of the first intersections is between the first end and the third end.

20. The optical system as claimed in claim 15, wherein:
when the movable part is in the first position,
the first end and the third end have different structures;
the second end and the third end have different structures;
the second middle part and the third middle part have different structures;
the first middle part and the third middle part have different structures;
the first middle part and the second middle part have different structures; and
when the movable part is in the second position, the third end is adjacent to the second opening, and another one of the second intersections is between the first end and the third end.
